(19) United States
(12) Patent Application Publication
(10) Pub. No.: US 2018/0355835 A1
(43) Pub. Date: Dec. 13, 2018

(54) BOUYANT HYDROELECTRIC POWER GENERATOR

(71) Applicant: Bryan Scott Lee, Olney, MD (US)

(72) Inventor: Bryan Scott Lee, Olney, MD (US)

(21) Appl. No.: 15/617,376

(22) Filed: Jun. 8, 2017

(51) Int. Cl. F03B 13/10; F03B 3/04; H02K 7/18

(52) U.S. Cl. CPC F03B 13/10; H02K 7/1823; F03B 3/04

(57) ABSTRACT

A hydroelectric generator for buoyantly generating electricity in a body of water, includes a support platform anchored in the body of water. A buoyancy chamber carried on the support platform is configured to selectively receive a source of air to buoyantly elevate the support platform through the body of water, and alternately sink the platform by discharging the air and flooding the chamber. A turbine array carried on the support platform is oriented to receive a relative water flow when the support platform ascends and descends through the body of water. An electric generator is operatively connected to the turbine. The system uses natural buoyancy to proactively drive an array of generating turbines through the water. The operator is in control of when electricity is generated and can choose to produce that electricity during times of peak demand when electricity prices are highest.

### BACKGROUND OF THE INVENTION

The present invention relates to hydroelectric power generation and, more particularly, to buoyant power generation systems and energy storage.

Hydroelectric power has long been harnessed from flowing waters in rivers and streams. Alternative hydroelectric power generation systems seek to harness waves, tides, and underwater currents in oceans and other large bodies of water. Because these systems depend on the timing and periodic nature of natural forces, such as waves and underwater currents to drive the turbines, they may be considered passive generating systems in that the operator is not in control of when power is generated. Accordingly, these systems may not be able to generate power when demand is highest.

As can be seen, there is a need for a system, method, and apparatus that provides for controlled generation of hydroelectric power, particularly when demand is high making electricity production most lucrative.

### SUMMARY OF THE INVENTION

In one aspect of the present invention, a hydroelectric generator for buoyantly generating electricity in a body of water includes a support platform configured to be anchored in the body of water. A buoyancy chamber is carried on the support platform and is configured to selectively receive a source of air to buoyantly elevate the support platform through the body of water. A turbine is carried on the support platform and is oriented to receive a relative water flow when the support platform is elevated through the body of water. An electric generator is operatively connected to the turbine.

A release valve in communication with the buoyancy chamber is selectively operable to discharge the source of air and flood the buoyancy chamber with water to sink the support platform. The turbine is oriented to receive the relative water flow when the buoyancy chamber is flooded with water and the support platform sinks. The system may also include a storage vessel that is in fluid communication with the buoyancy chamber. A pump is selectably operable to deliver a source of air to the storage vessel. The pump may be selected to operate during low energy demand periods.

The anchor may include a pivot such that the support platform is pivotally attached to the pivot via a support arm. The anchor may be configured for attachment to one of a bed in the body of water and a support pillar of a platform in the body of water. An electrical output of the generator is configured as an input to an electrical grid.

Other aspects of the invention include a method of generating hydroelectric power. The method includes providing a hydroelectric generator for buoyantly generating electricity in a body of water. The hydroelectric generator includes a support platform anchored in the body of water. A buoyancy chamber is carried on the support platform, and is configured to selectively receive a source of air to buoyantly elevate the support platform through the body of water. A turbine is carried on the support platform and oriented to receive a relative water flow when the support platform is elevated through the body of water and an electric generator is operatively connected to the turbine. The method includes providing the source of air to the buoyancy chamber to elevate the support platform through the body of water and generating electric power by the relative water flow entering the turbine as the support platform ascends. The method also includes discharging the air from the buoyancy chamber and flooding the chamber with water via a release valve and thereby generating electric power by the relative water flow entering the turbine as the support platform descends. Other aspects of the method include operating the hydroelectric generator during peak energy demand periods. And yet others include charging a storage vessel with the source of air, which may be pressurized, during a low energy demand period.

These and other features, aspects and advantages of the present invention will become better understood with reference to the following drawings, description and claims.

### BRIEF DESCRIPTION OF THE DRAWINGS

FIG. 1 is a schematic perspective view of an embodiment of buoyant hydroelectric power generator.

FIG. 2 is a schematic diagram of the invention in an idle state.

FIG. 3 is a schematic diagram of the invention in the first stage of electricity generation.

FIG. 4 is a schematic diagram of the invention in the second stage of electricity generation.

FIG. 5 is a schematic diagram of the invention in the final stage of electricity generation.

FIG. 6 is a schematic side elevation view of an alternative embodiment of buoyant hydroelectric power generator applied to an offshore structure.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Broadly, an embodiment of the present invention provides a system, method, and apparatus that utilizes natural buoyancy to actively drive turbines through the water, rather than placing turbines statically under water and where they are dependent on the periodic occurrence of tides, currents, or waves to drive the turbines. The system permits utilization of low-cost, off-peak electricity to produce and store a source of air, and then utilizes that air to drive hydroelectric turbines through the water to generate electricity during higher-cost peak demand times for electricity.

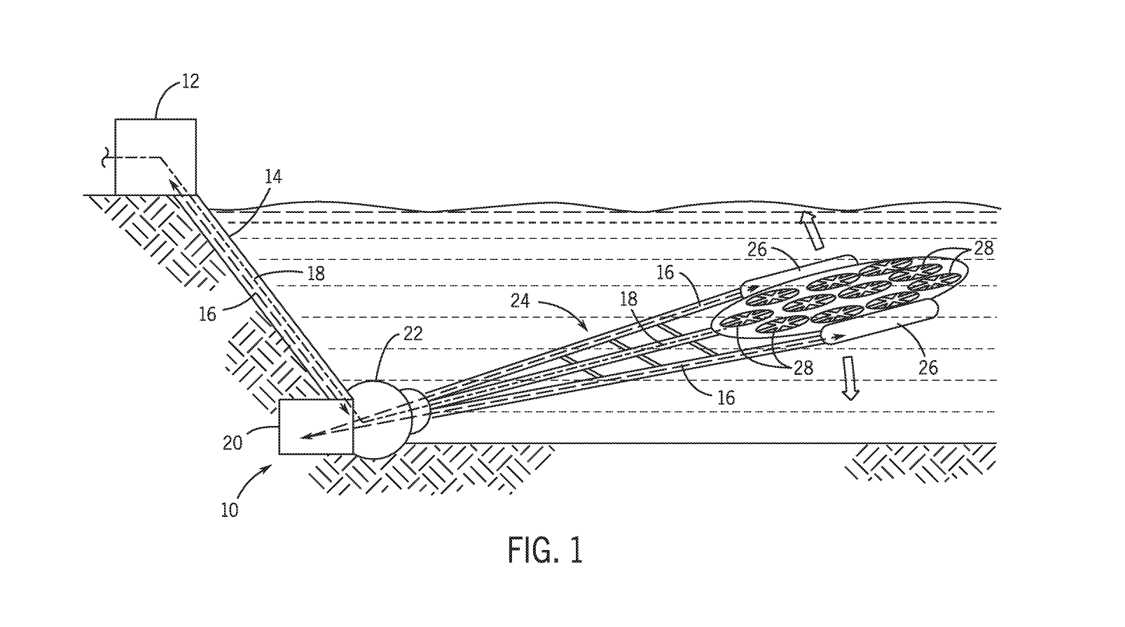

As seen in reference to FIG. 1, a buoyant hydroelectric power generation system 10 is illustrated deployed for operation in a body of water. The body of water may be a lake, ocean or high seas. The system 10 includes a pump house 12 that may be positioned on an adjoining shoreline or may be carried on a platform, such as an offshore oil rig, in the body of water. The system also includes a buoyant generation structure 24 that is carried in the body of water, where it may be selectively elevated and sunk within the body of water.

A conduit 14 extends between the pump house 12 and the buoyant generation structure 24. The conduit 14 is configured to carry one or more air lines to the structure 24 and one or more electric conductors to convey electricity generated by the structure 24. An underwater pumping station 20 may also be provided to facilitate the delivery of air and conveyance of electricity from the structure.

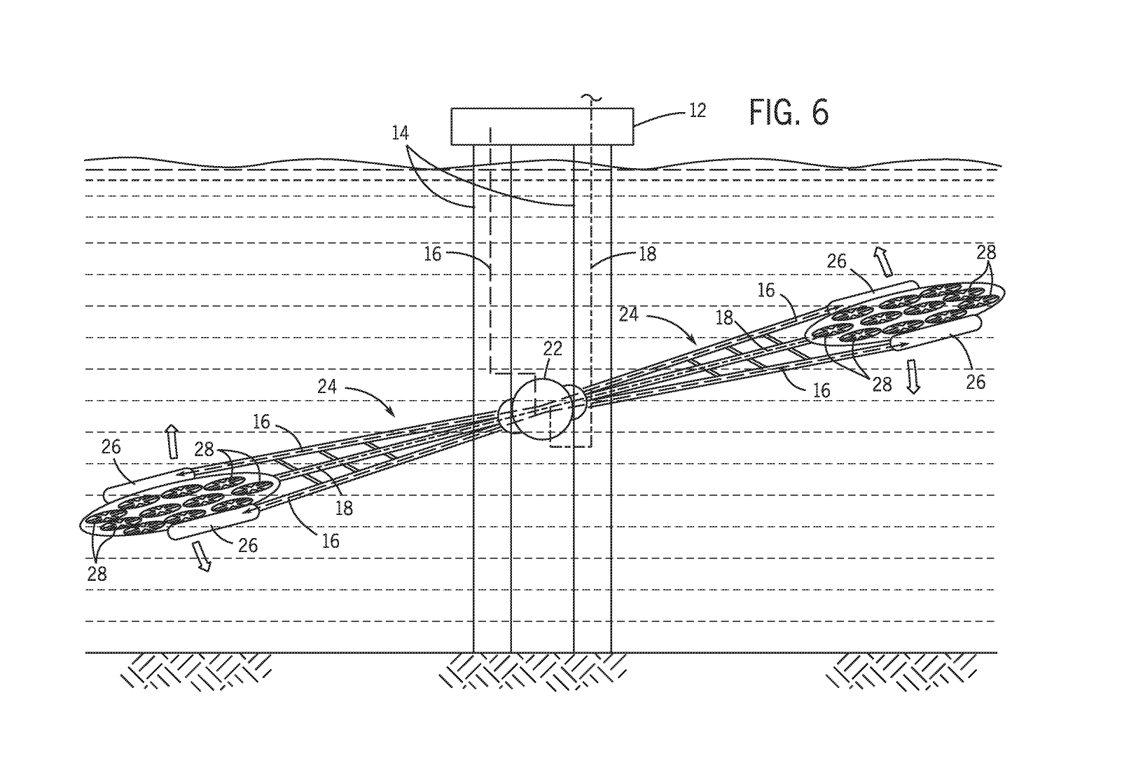

In some embodiments the structure 24 may be anchored on the lakebed or seabed by a pivot 22. The pivot 22 allows the pivotal movement of the structure 24 as the structure rises and falls during operation. In other embodiments, such as shown in FIG. 6, the pivot 22 may be secured to support pilings of an offshore platform. As further shown in FIG. 6, the structure 24 may be alternately opposed about the pivot 22, such that as one structure 24 is rising the opposite structure 24 is descending.

The structure 24 is selectively elevated and sunk within the body of water by conveying the air to fill one or more buoyancy chambers 26 that are coupled to the frame 24 and releasing the air from one or more release valves 27. The structure frame 24 carries a plurality of hydroelectric turbines 28 and associated generators 30 that are disposed for being driven by the flow of water through the turbine 28 as the structure is elevated and sunk.

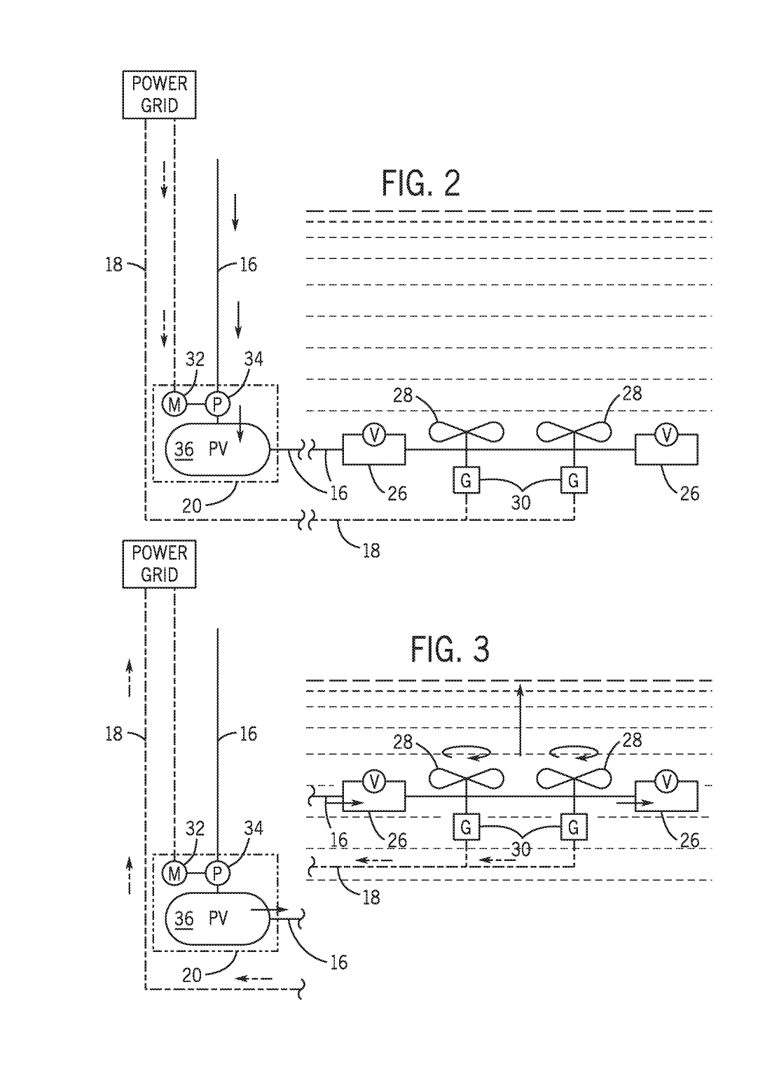

A power generation cycle of the system is shown in reference to FIGS. 2-5. In an initial condition, shown in FIG. 2, the buoyant generation structure 24 is shown at a lowered resting position. A volume of air from the pump house 12 is contained in a pressure or storage vessel 36 contained in the underwater pumping station 20. One of the pump house 12 or underwater pumping station contains a motor 32 to drive a pneumatic pump 34 to fill the storage vessel 36.

As seen in FIG. 3, release of the air from the storage vessel 36 is carried via the airlines 16 to discharge water from the chamber or chambers 26 making them buoyant and initiating an elevation generating cycle. As the buoyancy chambers 26 fill with air the structure 24 begins to rise in the body of water creating a relative water flow through the turbines 28. Rotation of the turbines 28 begins, which are operatively coupled to the generators 30, generates electric energy which is carried by the conductors 18 and carried to a power grid.

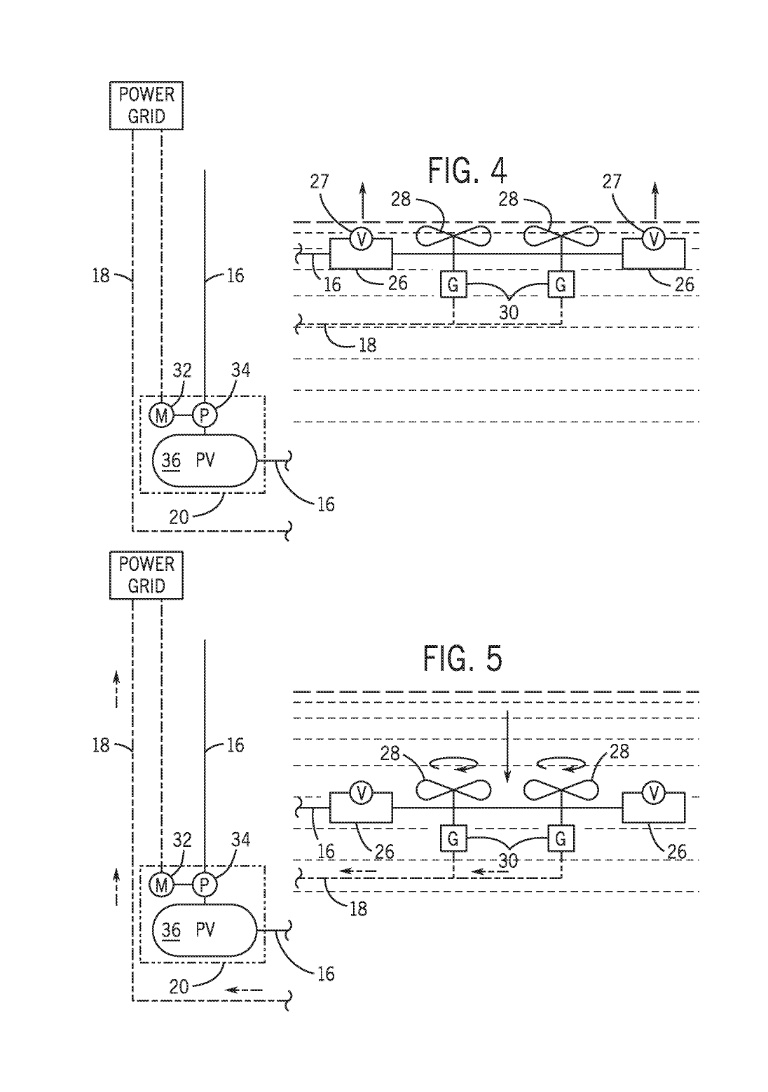

When the structure 24 reaches its maximum elevation, shown in reference to FIG. 4, the flow of water through the turbines 28 ceases and stops generation of the electric power by the generators 30. Activation of the one or more release valves 27 discharges the air contained in the buoyancy chambers 26 to flood them with water and initiate a sinking generation cycle.

As seen in reference to FIG. 5, as the air is vented from the buoyancy chambers 26, the no-longer-buoyant support structure 24 begins to descend which creates a relative water flow through the turbines 28 and associated power generation by the generators 30. Electricity produced during the sinking generation cycle is carried by the electrical conductors 18 for distribution to the power grid.

This cycles are repeated until the storage vessel 36 is exhausted of air. At night, when electricity is abundant and relatively inexpensive, the storage vessel 36 is again filled with air to propel the turbine array during the afternoon when electricity is in high demand. By generating electricity during peak demand periods, the operator is able to obtain a higher price for the electricity delivered to the power grid.

The structure 24 may be formed using corrosion-resistant steel, aluminum or advanced composite material structural members. The platform 24 is configured to support an array of electricity generation turbines 28 and associated generators 30. The platform 24 would be arranged between two or more arms that would recede to the stationary pivot point 22. Those arms could also serve as conduits for air feed lines 16 and electrical conductors 28. When the chambers 26 are filled with air, the turbine array platform 24 would rise, pivoting at the stationary pivot point 22, generating electricity that is conveyed back to shore through conductors 18. The elements described above are necessary. None is optional, although they potentially could be configured differently.

As contemplated herein, rather than use pivot arms 22, it would also be advantageous to configure the turbine array in a stationary column, such as a support pillar for an oil rig or other sea structure. The operator could use the system to convert electricity into stored air. That stored air would then be converted back to electricity by means of the buoyant array of turbines 28. The operator would thereby convert low-cost, off-peak electricity into higher-cost electricity during periods of peak demand. Accordingly, even if the process may result in a net loss of energy, it is economically a net positive by converting low-cost off-peak electricity into stored air, which is then used to generate electricity during peak-demand hours when electricity receives a price premium in the marketplace.

It should be understood, of course, that the foregoing relates to exemplary embodiments of the invention and that modifications may be made without departing from the spirit and scope of the invention as set forth in the following claims.

What is claimed is:

1. A hydroelectric generator for buoyantly generating electricity in a body of water comprising:
a support platform configured to be anchored in the body of water;
a buoyancy chamber carried on the support platform, configured to selectively receive a source of air to buoyantly elevate the support platform through the body of water;
a turbine carried on the support platform and oriented to receive a relative water flow when the support platform is elevated through the body of water; and
an electric generator operatively connected to the turbine.

2. The hydroelectric generator of claim 1, wherein the turbine comprises a turbine array.

3. The hydroelectric generator of claim 1, further comprising:
a release valve in communication with the buoyancy chamber that is selectively operable to discharge the source of air carried within the buoyancy chamber to flood the chamber and sink the support platform.

4. The hydroelectric generator of claim 3, wherein the turbine is oriented to receive a relative water flow when the support platform is sunk.

5. The hydroelectric generator of claim 4, further comprising:
a storage vessel in fluid communication with the buoyancy chamber.

6. The hydroelectric generator of claim 5, further comprising:
a pump selectably operable to deliver a source of air to the storage vessel.

7. The hydroelectric generator of claim 6, wherein the pump is selected to operate a during low energy demand period.

8. The hydroelectric generator of claim 6, wherein the anchor comprises a pivot and the support platform is pivotally attached to the pivot via a support arm.

9. The hydroelectric generator of claim 8, wherein the anchor is configured for attachment to one of a bed in the body of water and a support pillar of a platform in the body of water.

10. The hydroelectric generator of claim 1, wherein an electrical output of the generator is configured as an input to an electrical grid.

11. A method of generating hydroelectric power, comprising:
providing hydroelectric generator for buoyantly generating electricity in a body of water, the hydroelectric generator comprising:
a support platform anchored in the body of water;
a buoyancy chamber carried on the support platform, configured to selectively receive a source of air to buoyantly elevate the support platform through the body of water;
a turbine carried on the support platform and oriented to receive a relative water flow when the support platform is elevated through the body of water; and
an electric generator operatively connected to the turbine;
providing the source of air to the buoyancy chamber to elevate the support platform through the body of water; and
generating electric power by the relative water flow entering the turbine as the support platform ascends.

12. The method of claim 11, further comprising:
discharging the air and flooding the buoyancy chamber with water via a release valve in communication with the buoyancy chamber; and
generating electric power by the relative water flow entering the turbine as the no-longer-buoyant support platform descends.

13. The method of claim 12, further comprising:
operating the hydroelectric generator during a peak energy demand periods.

14. The method of claim 11, further comprising:
charging a storage vessel with the source of air during a low energy demand period.
